(19) United States
(12) Patent Application Publication
(10) Pub. No.: US 2002/0014717 A1
(43) Pub. Date: Feb. 7, 2002

(54) PROCESS FOR PRODUCING THERMOPLASTIC FILMS BY BLOWN FILM EXTRUSION AND FILMS PRODUCED THEREBY

(76) Inventors: SUSAN MARIE KLING, MIDLAND, MI (US); RENE KRUIDENIER, GOUDA (NL); ERIC K. C. LEE, MIDLAND, MI (US); MARTIN F. DEBNEY, MIDLAND, MI (US)

Correspondence Address: STEPHENS S GRACE, P O BOX 1967, MIDLAND, MI, 486411967

(21) Appl. No.: 09/281,837

(22) Filed: Mar. 31, 1999

(51) Int. Cl. B29C 63/06

(52) U.S. Cl. 264/171.27; 428/507; 428/508; 428/510; 264/209.5; 264/210.3

(57) ABSTRACT

A process for making a thermoplastic film by the blown film extrusion process comprises extruding a molten thermoplastic polymer through a tubular die to form a tube of molten polymer, contacting the inner surface of the tube of molten polymer as it exits the die with an aqueous solution of a water-soluble polysaccharide ether, inflating the tube of molten polymer to form a blown tubular film and then collapsing the blown film to a flat web. The thermoplastic film has on its surface a coating of a water-soluble polysaccharide ether.

### BACKGROUND OF THE INVENTION

This invention relates to a process for producing thermoplastic films by blown film extrusion.

Blown film extrusion processes are known and are described, for example, in U.S. Pat. Nos. 2,409,521, 2,476,140, 2,634,459, 3,750,948, 4,997,616, 5,213,725, and 5,700,489. In the blown film extrusion process, a molten thermoplastic polymer is extruded through a tubular die. The extruded molten polymer exits the die as an amorphous polymer tube and formed into a bubble or blown film by the pressure of internal air. The blown film is collapsed into a flat web. Typically, a mineral oil/water solution (sock solution) is introduced into or recirculated in the amorphous polymer tube as it exits the extruder die to maintain the temperature of the amorphous polymer tube (sock) and its contents in a uniform manner. The sock solution also helps reduce interply air entrapment and controls interply adhesion of the amorphous tube and finished film. The control of the interply adhesion limits the extent of the welding of the edges of the amorphous web as the amorphous tube is collapsed to a flat web. In a single-wound film, the sock solution allows the film layer to be easily separated for winding on rolls of single-ply films. For a double-wound film, where the finished film is not separated but wound as two layers onto rolls, the sock solution provides an interply adhesion both on fresh and aged films with minimal edge welds. The term “interply adhesion” refers to the adhesion between opposing surfaces of the polymer tube when the tube is flattened between the last set of nip rolls and is wound as two film layers (two-ply film) onto rolls.

It would be desirable to provide materials which can be used as a sock solution in blown film extrusion processes which exhibit better performance than mineral oil.

### SUMMARY OF THE INVENTION

In a first aspect, the present invention is a process for making a thermoplastic film by the blown film extrusion process which comprises extruding a molten thermoplastic polymer through a tubular die to form a tube of molten polymer, contacting the inner surface of the tube of molten polymer as it exits the die with an aqueous solution of a water-soluble polysaccharide ether, inflating the tube of molten polymer to form a blown tubular film and then collapsing the blown film to a flat web.

In a second aspect, the present invention is a thermoplastic film having a coating of a water-soluble polysaccharide ether.

### BRIEF DESCRIPTION OF THE DRAWING

FIG. 1 is a schematic diagram showing the device and process employed in the present invention.

### DETAILED DESCRIPTION OF THE INVENTION

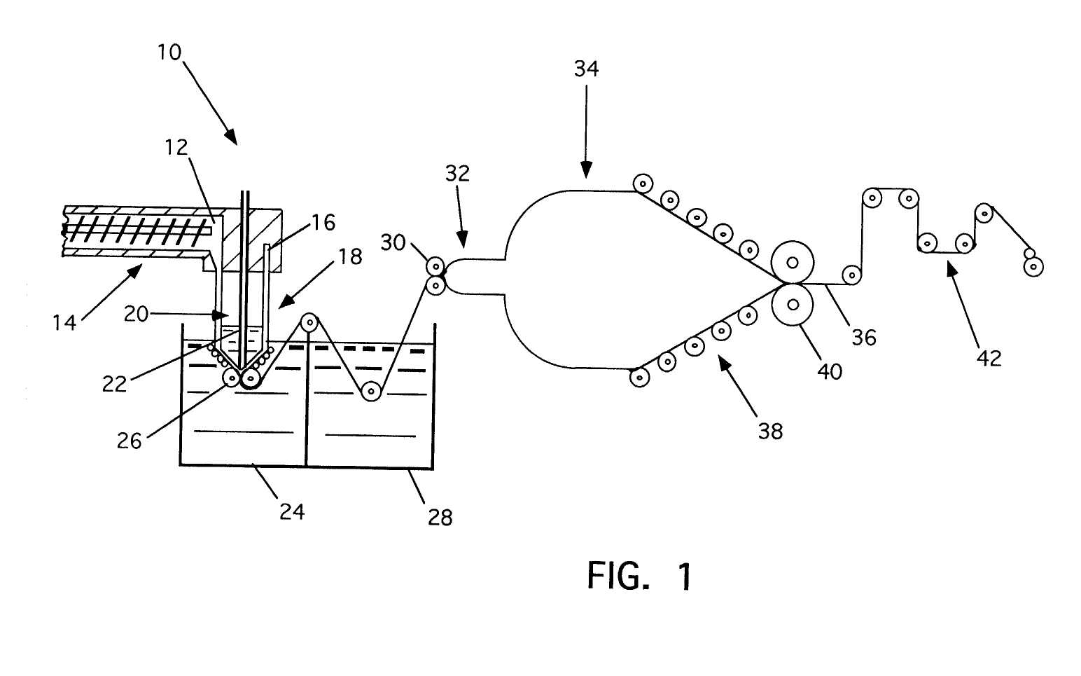

Referring now to the drawings, there is shown in FIG. 1 a conventional device 10 employed in the process of the present invention. A thermoplastic polymer 12 is extruded through an extruder 14 and exits through a tubular die 16. As polymer tube 18 exits die 16, its inner surface is contacted with a sock solution 20 comprising an aqueous solution of a water-soluble polysaccharide ether. Sock solution 20 is fed into the polymer tube 18 through a conduit 22. Polymer tube 18 is rapidly cooled to about 5° C. to 20° C. in quench bath 24, to render it amorphous and then flattened by passing it through a first set of nip rolls 26. The flattened amorphous tube is then reheated to 25° C. to 30° C. in reheat bath 28 and passed through a second set of nip rolls 30 outside the reheat bath. Between the second set of nip rolls 30 and a third set of nip rolls 40, air is introduced into the amorphous tube 32 to stretch it in the transverse direction and expands it to a larger diameter (about 4 times its original diameter), forming a blown bubble 34. At the same time, the third set of nip rolls 40, which runs at a greater speed than the second set of nip rolls 30, stretches the tube in the machine direction. Blown bubble 34 is then collapsed to a flat web 36 having two plies of films by passing it through guiding devices 38 into the third set of nip rolls 40. The flat web is then taken up on a winder 42 and double-wound as a two-ply film. The double-wound two-ply film has a coating of a water-soluble polysaccharide disposed between the two plies. The double-wound film can also be slit into a single-wound, single-ply film having on one of its surfaces a coating of a water-soluble cellulose ether.

Thermoplastic polymers which can be employed in the practice of the present invention include vinylidene chloride polymers, vinyl chloride polymers, polyethylene terephthalate, polypropylene, polystyrene, polycarbonate, polyamide, ethylene vinyl alcohol.

Vinylidene chloride polymers suitable for use in the present invention are well-known in the art. See, for example, U.S. Pat. Nos. 3,642,743; and 3,879,359. The most common PVDC resins are known as Saran™ resins, manufactured by The Dow Chemical Company. As used herein, the term “vinylidene chloride polymer” or “PVDC” encompasses homopolymers of vinylidene chloride, and also copolymers and terpolymers thereof, wherein the major component is vinylidene chloride and the remainder is one or more monoethylenically unsaturated monomer copolymerizable with the vinylidene chloride monomer.

As used herein, the term “vinyl chloride polymer” or “PVC” encompasses homopolymers of vinyl chloride, and also copolymers and terpolymers thereof, wherein the major component is vinyl chloride and the remainder is one or more monoethylenically unsaturated monomer copolymerizable with the vinylidene chloride monomer.

Monoethylenically unsaturated monomers which can be employed in the practice of the present invention for preparing the vinylidene chloride polymers or vinyl chord polymers include vinyl chloride, alkyl acrylates, alkyl methacrylates, acrylic acid, methacrylic acid, itaconic acid, acrylonitrile, methacrylonitrile, and the like. Preferred ethylenically unsaturated monomers include vinyl chloride, acrylonitrile, methacrylonitrile, alkyl acrylates, and alkyl methacrylates.

Polysaccharides are known and are described, for example, in Encyclopedia of Polymer Science and Technology, 2^{nd} edition, 1987. The preferred polysaccharides are cellulose and starch.

The polysaccharide ethers which can be employed in the practice of the present invention for preparing the sock solution are, for example, cellulose ethers and cellulose esters, or starch esters and starch ethers. Such polysaccharide ethers are known and are described, for example, in Encyclopedia of Polymer Science and Technology, 2^{nd} edition, 1987.

Celluloses are known and are described, for example, in Encyclopedia of Polymer Science and Technology, 2^{nd} edition, 1987. Celluloses are natural carbohydrate high polymers (polysaccharides) consisting of anhydroglucose units joined by an oxygen linkage to form long molecular chains that are essentially linear. Cellulose can be hydrolyzed to form glucose. The degree of polymerization ranges from 1000 for wood pulp to 3500 for cotton fiber, giving a molecular weight of from 160,000 to 560,000. Cellulose can be extracted from vegetable tissues (wood, grass, and cotton). Celluloses can be used in the form of fibers.

The term “starch” as used herein, refers to carbohydrates of natural, vegetable origin, composed mainly of amylose and/or amylopectin, and includes unmodified starches, physically modified starches, such as thermoplastic, gelatinized or cooked starches, starches with a modified acid value (pH) where acid has been added to lower the acid value of a starch to a range of from 3 to 6, gelatinized starches, ungelatinized starches, cross-linked starches and disrupted starches (starches which are not in particulate form). The starches can be in granular, particulate or powder form. They can be extracted from various plants, such as, for example, potatoes, rice, tapioca, corn, pea, and cereals such as rye, oats, and wheat.

Preferably, the water-soluble polysaccharide ethers which can be employed in the practice of the present invention for preparing the sock solution include water-soluble, nonionic cellulose ethers, such as methylcellulose, ethylcellulose, hydroxypropylcellulose, hydroxypropyl methylcellulose and similar synthetic cellulose ethers. Most preferred nonionic cellulose ethers are METHOCEL™ cellulose ethers, trademarked products of The Dow Chemical Company.

Other suitable synthetic cellulose ethers which can be employed in the present invention for preparing the sock solution include ionic cellulose ethers such as, for example, carboxymethylcellulose, carboxymethylethylcellulose, carboxymethylhydroxyethyl cellulose and their water-soluble salts.

The water-soluble nonionic and ionic cellulose ethers form thermally reversible gels in aqueous solutions. These cellulose ethers are known in the art and can be prepared, for example, by the process described in U.S. Pat. Nos. 2,831,852 and 2,835,666.

In general, the sock solution can be prepared by dispersing a cellulose ether in hot water and then adding the dispersion to cold water or the cold water may be added to the dispersion. While the amount of cellulose ether most advantageously employed depends on a variety of factors, such as the specific cellulose ether, in general, the cellulose ether is used in a ratio of 1 part cellulose ether to 5 to 30 parts water.

The cellulose ether can also be dispersed in nonsolvent media, such as vegetable oil, propylene glycol, polyethylene glycol and glycerine, preferably in a ratio of 5 to 8 parts nonsolvent to 1 part cellulose ether, and the dispersion added to cold water or the cold water is added to the dispersion.

The sock solution of the present invention can also be used in a double bubble process. In such a process, the polysaccharide sock solution is introduced inside the bubble, at the lower end of the primary bubble. The double bubble process for making films are known in the art. See, for example, U.S. Pat. No. 5,674,607. In general, the double bubble process comprises extruding a polymeric material, such as vinylidene chloride polymer, through an extruder. The extruded film is hot-blown by conventional techniques to form a blown bubble, commonly called the primary bubble. The primary bubble is air-cooled as it exits the die and then melt-oriented in both the machine and transverse directions. The oriented primary bubble is collapsed by passing it through a first set of nip rolls and then reinflated in a blown bubble process to stretch-orient the blown and collapsed film and produce what is known in the art as the secondary bubble. This is done in a conventional manner by trapping air or other hot gas within the secondary bubble so that the material stretches at its orientation temperature transversely to impart further orientation of the material in the transverse direction. The secondary bubble is collapsed at a second set of nip rolls. The second set of nip rolls is rotated at a speed faster than the first set of nip rolls to impart stretch orientation in the machine or longitudinal direction to the thermoplastic material. The re-collapsed bubble then passes from the second set of nip rolls to a take up roll. The double bubble process for making films is known. See, for example, U.S. Pat. No. 5,674,607.

The present invention is illustrated in further detail by the following examples. The examples are for the purposes of illustration only, and are not to be construed as limiting the scope of the present invention. All parts and percentages are by weight unless otherwise specifically noted.

The following materials are used in the Examples:

METHOCEL A—A methyl cellulose ether sold by The Dow Chemical Company as METHOCEL K3 Premium LV. It contains on average 22% methoxyl and 8.1% hydroxypropyl substitution on the cellulose backbone. The METHOCEL solution has a viscosity of ˜3 centipoise as measured using ASTM standards D1347 and D2363.

METHOCEL B—A methyl cellulose ether sold by The Dow Chemical Company as METHOCEL K100 Premium LV. It contains on average 22% methoxyl and 8.1% hydroxypropyl substitution on the cellulose backbone. The METHOCEL solution has a viscosity of ˜100 centipoise as measured using ASTM standards D1347 and D2363.

Saran A—A vinylidene chloride polymer composition comprising 99.63% of a vinylidene chloride copolymer (˜18% vinyl chloride and 82% vinylidene chloride and ˜4% dibutyl sebacate and ˜1% epoxidized soybean oil), 0.2% epoxidized soybean oil and 0.17% fatty acid amide slip agent and inorganic antiblock agent.

Saran B—A vinylidene chloride polymer composition comprising 99.33% of a vinylidene chloride copolymer (˜18% vinyl chloride and 82% vinylidene chloride and ˜4% dibutyl sebacate and ˜1% epoxidized soybean oil), 0.2% epoxidized soybean oil and 0.47% of a composition comprising a fatty acid amide slip agent, an inorganic antiblock agent and a red pigment.

### EXAMPLE 1

METHOCEL A and METHOCEL B were evaluated as sock opening agents in the extrusion of Saran A.

### Procedure

A control with mineral oil as the sock solution and Saran A was established at a set of constant extrusion conditions and bath and sock temperatures. The amount of edge welding of the control extrusion was noted. A sample of the control film was collected for comparison of interply adhesion. A fluid reservoir and associated piping and pumps was then installed. This fluid reservoir recirculates the sock fluids and controls the concentration of the sock fluid by allowing addition of the sock opening agents to increase the concentration as well as draining and dilution to decrease the concentration. Samples of films made with METHOCEL A and METHOCEL B sock fluids at different concentrations were collected for comparison of the interply adhesion. The degree of edge weld at each concentration was also noted. The results are shown in Table I.

As used herein, the term “edge welding” or “edge weld” refers to the tendency of the two-ply of the amorphous tape to stick together near the edge. Edge sticking manifests itself immediately after the warm tank nips as a non-uniform expansion of the amorphous tape.

TABLE I

| Sock Fluid | Edge Weld | Interply Adhesion |
|---|---|---|
| Mineral Oil | 1.5″ both edges | Very weak at 1 day |
| Control | Cold tank = 17° C. | |
| | Warm tank = 35° C. | |
| | Sock = 24° C. | |

10% METHOCEL A
Solution
Dosage:

| | | |
|---|---|---|
| a) 360 mL in sock | Marginal in tape | Strong with fresh |
| | opening | film |
| | 5″ and 2″ welds | |
| b) 560 mL in sock | Just sufficient | Strong with fresh |
| | tape opening | film |
| | 4″ and 1.5″ welds | |
| c) 840 mL in sock | Better tape | Strong (1 day old |
| | opening | film) |
| | 3″ and 1″ weld | |

4.3% METHOCEL B
Solution
Dosage:

| | | |
|---|---|---|
| a) 150 mL in sock | Excellent tape | Strong (1 day |
| | opening | film) |
| | 0.5″ weld both | |
| | edges | |
| b) 4 times | Excellent tape | Strong |
| dilution of a) | opening | |
| | 0.5″ weld both | |
| | edges | |
| c) 4 times | Good tape opening | Strong |
| dilution of b) | 2″ and 0.5″ weld | |
| | both edges | |

### EXAMPLE 2

METHOCEL A was evaluated as the sock opening agent (5% METHOCEL A in water) in the extrusion of Saran A.

### Procedure

A control with mineral oil as the sock solution and Saran A was established at a set of constant extrusion conditions and bath and sock temperatures. A sample of the control film was collected for comparison of interply adhesion. A fluid reservoir was then installed. This fluid reservoir recirculated and cooled the sock fluid. A sample of film made with the Methocel A sock fluids was collected for comparison of the interply adhesion.

Interply adhesion was determined on fresh and on aged films. The results are shown in Table II.

TABLE II

| Sock Fluid | Interply Adhesion | Interply Adhesion |
|---|---|---|
| Mineral Oil | 12 gram at fresh | 15 gram at 21 days |
| Control | film (1 day old) | aged film |
| 5% Methocel A | 19 gram at fresh | 22 gram at 21 days |
| Solution | film (1 day old) | aged film |

### EXAMPLE 3

The procedure of Example 2 was followed except that Saran B was used instead of Saran A. The results are shown in Table III.

TABLE III

| Sock Fluid | Interply Adhesion | Interply Adhesion |
|---|---|---|
| Mineral Oil | 10 gram at fresh | 12 gram at 21 days |
| Control | film (1 day old) | aged film |
| 5% Methocel A | 16 gram at fresh | 17 gram at 21 days |
| Solution | film (1 day old) | aged film |

The above results show that Methocel A and Methocel B perform better than mineral oil as a sock solution.

What is claimed is:

1. A process for making a thermoplastic film by the blown film extrusion process which comprises extruding a molten thermoplastic polymer through a tubular die to form a tube of molten polymer, contacting the inner surface of the tube of molten polymer as it exits the die with an aqueous solution of a water-soluble polysaccharide ether, inflating the tube of molten polymer to form a blown tubular film and then collapsing the blown film to a flat web.

2. The process of claim 1 wherein the thermoplastic polymer is a vinylidene chloride polymer, vinyl chloride polymer, polyethylene terephthalate, polypropylene, polystyrene, polycarbonate, polyamide or ethylene vinyl alcohol.

3. The process of claim 1 wherein the thermoplastic polymer is a vinylidene chloride polymer comprising a major amount of vinylidene chloride and a minor amount of one or more monoethylenically unsaturated monomer copolymerizable with the vinylidene chloride monomer.

4. The process of claim 1 wherein the thermoplastic polymer is a vinyl chloride polymer comprising a major amount of vinyl chloride and a minor amount of one or more monoethylenically unsaturated monomer copolymerizable with the vinyl chloride monomer.

5. The process of claim 1 wherein the polysaccharide is a water-soluble nonionic or ionic cellulose ether or a water-soluble salt thereof.

6. The process of claim 5 wherein the water-soluble nonionic cellulose ether is methylcellulose, ethylcellulose, hydroxypropylcellulose or hydroxypropyl methylcellulose.

7. The process of claim 6 wherein the water-soluble nonionic cellulose ether is methylcellulose.

8. The process of claim 5 wherein the water-soluble ionic cellulose ether is carboxymethylcellulose, carboxymethylethylcellulose or carboxymethylhydroxyethyl cellulose.

9. The process of claim 1 wherein the aqueous solution of water-soluble polysaccharide ether comprises 1 part of cellulose ether and from 5 to 30 parts of water.

10. A thermoplastic film having a coating of a water-soluble polysaccharide ether.

11. The thermoplastic film of claim 10 comprising a vinylidene chloride polymer, vinyl chloride polymer, polyethylene terephthalate, polypropylene, polystyrene, polycarbonate, polyamide or ethylene vinyl alcohol.

12. The thermoplastic film of claim 11 wherein the vinylidene chloride polymer comprises a major amount of vinylidene chloride and a minor amount of one or more monoethylenically unsaturated monomer copolymerizable with the vinylidene chloride monomer.

13. The thermoplastic film of claim 10 wherein the vinyl chloride polymer comprises a major amount of vinyl chloride and a minor amount of one or more monoethylenically unsaturated monomer copolymerizable with the vinyl chloride monomer.

14. The thermoplastic film of claim 10 wherein the water-soluble polysaccharide ether is a water-soluble nonionic or ionic cellulose ether or a water-soluble salt thereof.

15. The thermoplastic film of claim 14 wherein the water-soluble nonionic cellulose ether is methylcellulose, ethylcellulose, hydroxypropylcellulose or hydroxypropyl methylcellulose.

16. The thermoplastic film of claim 15 wherein the water-soluble nonionic cellulose ether is methylcellulose.

17. The thermoplastic film of claim 14 wherein the water-soluble ionic cellulose ether is carboxymethylcellulose, carboxymethylethylcellulose or carboxymethylhydroxyethyl cellulose.

18. The thermoplastic film of claim 10 comprising a single-ply film having a coating of a water-soluble polysaccharide ether on one of its two major surfaces.

19. The thermoplastic film of claim 10 comprising a double-ply film having a coating of a water-soluble polysaccharide ether disposed between its two adjacent plies.
